(19) United States
(12) Patent Application Publication
(10) Pub. No.: US 2023/0262102 A1
(43) Pub. Date: Aug. 17, 2023

(54) DYNAMIC VIRTUAL BACKGROUND IMAGE SELECTION FOR A VIDEO COLLABORATION SESSION

(71) Applicant: Cisco Technology, Inc., San Jose, CA (US)

(72) Inventors: Athul M. Das, Kerala (IN); Kishore Vadde, Bangalore (IN); Ram Mohan Ravindranath, Karnataka (IN); Srinivas V L N Akella, Bangalore (IN); David Benjamin Galaun, London (GB)

(21) Appl. No.: 17/673,231

(22) Filed: Feb. 16, 2022

(51) Int. Cl. H04L 65/403; G06F 3/0484; H04L 65/1066

(52) U.S. Cl. CPC H04L 65/403; G06F 3/0484; H04L 65/1066

(57) ABSTRACT

Presented herein are techniques to facilitate dynamic virtual background image selection for a video collaboration session. In one example, a method may include storing each of a plurality of virtual background images for a first user of a video collaboration system in association with one or more keywords; and upon initiation of a video collaboration session for the first user, automatically providing a first virtual background image for the first user based, at least in part, on at least one of, a first context keyword for the session matching at least one keyword stored in association with the first image or scheduling information associated with the session. In one instance, the method automatically providing a second virtual background image for the first user based on a second context keyword obtained from a transcript of the session that matches at least one keyword stored in association with the second image.

### TECHNICAL FIELD

The present disclosure relates to network equipment and services.

### BACKGROUND

The remote work situation imposed by the Covid-19 pandemic has increased the use of video collaboration or teleconference systems, which are often used to conduct meetings, connect with co-workers, or interact with family. Current video collaboration systems provide for using virtual background images that allow a meeting participant to hide their actual background from other meeting participants.

### BRIEF DESCRIPTION OF THE DRAWINGS

FIG. 1 is a block diagram of a video collaboration system in which techniques may be implemented to facilitate dynamic virtual background image selection for a video collaboration session, according to an example embodiment.

FIGS. 2A, 2B, 2C, and 2D illustrate various example user interfaces that may be utilized for providing virtual background image user preference(s) associated with scheduling information for a video collaboration session, according to various example embodiments.

FIGS. 3A and 3B are a message sequence diagram illustrating a call flow associated with providing dynamic virtual background image selection for a video collaboration session, according to an example embodiment.

FIG. 4 is a flow chart depicting a method according to an example embodiment.

FIG. 5 is another flow chart depicting another method according to an example embodiment.

FIG. 6 is a hardware block diagram of a computing device that may perform functions associated with any combination of operations, in connection with the techniques discussed herein.

### DESCRIPTION OF EXAMPLE EMBODIMENTS

### Overview

For many video collaboration sessions, such as teleconferences, conference calls, meetings, virtual happy hours, etc., collaboration session attendees are often located at home or far away from each other. This is especially true throughout Covid-19 global pandemic. Many collaboration sessions (e.g., professional/business meetings, etc.) often begin and end with some casual chat/conversation.

In current video collaboration systems, it is possible to set a virtual background image for use during a video collaboration session. In some instances, a virtual background image can be set in advance of or upon initiating a session (e.g., at dial-in) or during the session. However, the virtual background image is static and remains the same unless changed by a user. Thus, setting or changing a virtual background image often involves a manual process, which can be inconvenient.

Thus, it would be useful if the background image of a video collaboration session could be changed dynamically, based on scheduling information provided for the session and/or from context information determined for the session, such as from an agenda and/or subject/title of a session determined upon initiation of the session and/or from conversation among session participants/users determined during the session. For example, during a session, if the discussion among session participants is casual, such as a particular participant discussing having a beach vacation, it may help to influence the mood of the discussion and the group if the background image for the particular participant or the group, collectively, could be dynamically changed/switched to a beach image or the like (under an assumption that the user/group has enabled such dynamic image switching).

Presented herein are techniques to facilitate dynamic virtual background image selection for video collaboration sessions, which may help to enhance the virtual collaboration experience by automatically changing the virtual background of a video collaboration session based on scheduling information for the session or the context of the session, which can be determined based on any combination of an agenda for the session, the role(s) of one or more participant(s)/user(s) involved in the session, and/or ongoing conversations during the session. In some instances, machine learning (ML) techniques/algorithms may be utilized to determine the context of a video collaboration session. Additionally, various security techniques may be utilized to secure user privacy in accordance with embodiments described herein. Thus, techniques described herein provide for the ability to automatically adjust virtual background images for one or more video collaboration session participants/users, with limited manual intervention.

In one embodiment, a method is provided that may include storing each of a plurality of virtual background images for a first user of a video collaboration system in association with one or more keywords; and upon initiation of a video collaboration session for the first user via the video collaboration system, automatically providing a first virtual background image for the first user based, at least in part, on at least one of, a first context keyword for the video collaboration session matching at least one keyword stored in association with the first virtual background image or scheduling information associated with the video collaboration session. In one instance, the method may further include obtaining, during the video collaboration session, a transcript of the video collaboration session; determining a second context keyword based on the transcript; and automatically providing a second virtual background image for the first user based on the second context keyword matching at least one keyword stored in association with the second virtual background image.

### Example Embodiments

Current video collaboration systems support the ability for session (e.g., meeting) participants or users to set a virtual background image to a pre-determined static background image. This can provide the users some privacy by hiding their actual background from other meeting participants. This can be especially useful in situations in which a user is attending a meeting from home, locations where the background is not appropriate for a meeting, etc. Currently, there are no mechanisms through which virtual background images can by dynamically set for a user based on scheduling information for a video collaboration session, context information for the meeting, or preferences provided by the user. Furthermore, there are also no mechanisms through which virtual background images can be dynamically changed for a user based on the context or topics being discussed during a video collaboration session.

With more and more organizations embracing hybrid work models in which employees can work from any combination of corporate or remote locations, it may be advantageous to enhance the virtual background image experience for video collaboration sessions, whereby certain virtual background images may be dynamically provided for one or more user(s) upon initiation of a video collaboration session based on scheduling information for the session and/or the context of the session and, further, whereby dynamic background images could be switched or updated for one or more users based on the context of ongoing discussions during a video collaboration session (e.g., meeting).

For example, it may be desirable for a user to utilize a certain background image for work collaboration sessions (or a certain image selected from a group of images designated by the user as ‘work’ images) and a different background image for personal collaboration sessions (or a certain image selected from a group of images designated by the user as ‘personal’ images). In another example, a consultant who works on behalf of two different clients may want to use one background image when working for client #1 and a different background image when working for client #2. The consultant might have meetings on behalf of both clients throughout a working day such that it may be inconvenient and time consuming to have to manually change the virtual background image before the start of each meeting. It may also be problematic/embarrassing if the consultant forgets to change the virtual background image before the start of the meeting.

In yet another example, a user may desire to use a certain background image for daytime meetings and a different background for nighttime meetings. Furthermore, in some instances, it may be desirable to use a certain background when there is a light color or a window in the view of a user's camera that is used during a video collaboration session, and a different background when there is a dark color/wall in the camera view. This might occur if someone were to work in different rooms of a house, different areas/meeting rooms of an office, different cafes, etc.

Still other scenarios may be considered through which dynamic background images may be switched/updated for one or more user(s) during the course of a video collaboration session. For example, in a training/all-hands meeting or the like where there is a fixed agenda involving multiple, diverse topics and/or speakers, it could be useful to switch the virtual background image(s) of user(s) based on the context of the meeting and/or the role of a given user at a particular point in time of the meeting (e.g., presenter or non-presenter). In another example, for online classroom settings or the like in which there are specific time slots for specific subjects, if could be useful to change the virtual background image of an augmented reality and/or virtual reality (AR/VR) room that includes all students and teachers participating in the class based on a given subject that is being taught for a particular time slot. In yet another example, for recurring/daily meetings, etc. it could be useful to learn the past behaviors or intents of meeting participants, with reference to particular virtual background images used by the meeting participants, in order to recommend a potential virtual background image for users based on the learned intents/selections of the users.

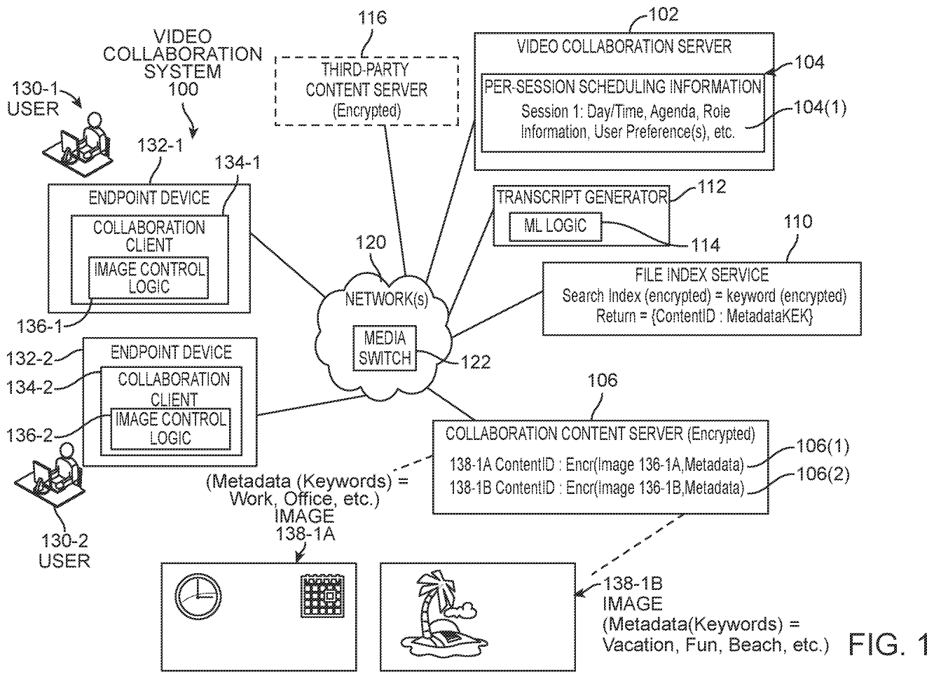

Referring to FIG. 1, FIG. 1 is a block diagram of a video collaboration system 100 in which techniques may be implemented to facilitate dynamic background image selection for at least one user participating in a video collaboration session, according to an example embodiment. As shown in FIG. 1, video collaboration system 100 may include a video collaboration server 102, a collaboration content server 106, a file index service 110, a transcript generator 112, and at least one network 120, which may include at least one media switch 122. A number of endpoint devices, each associated with a particular participant or user, are also shown in FIG. 1, such as an endpoint device 132-1 associated with a user 130-1 and an endpoint device 132-2 associated with a user 130-2 in which each endpoint device 132-1 and 132-2 communicates with video collaboration server 102 via network(s) 120 and media switch 122. Networks(s) 120 and media switch 122 may also facilitate communications among other elements/devices that may be present in video collaboration system 100, such as collaboration content server 106, transcript generator 112, and, in some instances one or more third-party content servers repositories/systems, such as third-party content server 116.

The video collaboration server 102 is configured to provide an online video collaboration service for hosting one or more video collaboration sessions among endpoint devices 132-1 and 132-2. In one example, video collaboration server 102 may be implemented as a Webex® server. Webex® is a registered trademark of Cisco Technology, Inc. Each endpoint device 132-1 and 132-2 may execute a corresponding collaboration client 134-1 and 134-2 to facilitate communications with video collaboration server 102, as well as to facilitate scheduling, controlling, and/or otherwise managing user participation in one or more video collaboration sessions (e.g., meetings, etc.) supported/hosted via video collaboration server 102. Thus, per-session scheduling information 104 (discussed in further detail herein, below) may be configured and stored for one or more video collaboration sessions involving user 130-1 and user 130-2. It is to be understood that any number of users/endpoint devices and/or any number of video collaboration servers may be present in video collaboration system 100 and that any number of users may participant in any combination of one or more video collaboration sessions hosted via video collaboration server 102.

In various embodiments, the respective endpoint devices 132-1 and 132-2 may be laptop computers, desktop computers, tablets, smartphones, video conference endpoints, or any other endpoint device now known or hereafter developed that can run a meeting client, such as collaboration client 134-1 configured for endpoint device 132-1 and collaboration client 134-2 configured for endpoint device 132-2. Respective collaboration clients 134-1 and 134-2 may be configured with additional logic, etc., such as respective image control logic 136-1 and 136-2, in order to facilitate dynamic virtual background image selection functionality as discussed for embodiments herein. In some instances, image control logic 136-1 and 136-2 may include artificial intelligence (AI)/machine learning (ML) logic in order to learn/predict behaviors and/or intents of users 130-1 and 130-2 based on various inputs provided by the users in approving or disapproving of the user of certain image(s) for certain different contexts/topics/etc., to learn behaviors and/or intents of users 130-1 and 130-2 based on previous collaboration sessions (e.g., recurring meetings) involving similar topics and/or participants, combinations thereof, and/or the like.

Endpoint devices 132-1 and 132-2 may include a display screen and other user input functionality (video camera, microphone, keyboard, etc.) to enable the respective users 130-1 and 130-2 operating respective endpoint devices 132-1 and 132-2 to participate in video collaboration sessions hosted via video collaboration server 102. The network(s) 120 may include any combination of wired local and/or wide-area networks as well as wireless local and/or wide-area networks. In some instances, endpoint devices 132-1 and 132-2 may also be configured with any combination of short-range wireless system connectivity (e.g., Bluetooth™, Wi-Fi®, wireless system capability, ultrasound communication capability, etc.) and/or long-range wireless system connectivity (e.g., cellular system capability) to enable local and/or wide-area wireless connectivity with network(s) 120.

Further for video collaboration system 100, collaboration content server 106 and, in some embodiments (if configured) third-party content server 116 can facilitate securely storing, managing, and/or retrieving one or more virtual background image(s) as configured by each of users 130-1 and 130-2 via corresponding endpoint devices 132-1 and 132-2, as discussed in further detail herein, below. The images stored in collaboration content server 106 and, if applicable, third-party content server 116, can be utilized via video collaboration server 102 and collaboration clients 134-1 and 134-2 to display corresponding virtual background images for corresponding users 130-1 and 130-2 in the video feeds/streams for each corresponding user, such that each user can be displayed in the foreground with the corresponding virtual background images being displayed in the background during a video collaboration session. In some instances, one or more virtual background images can also be stored on endpoint devices 132-1 and 132-2, which can be utilized for video collaboration sessions, in accordance with embodiments herein.

As shown in FIG. 1, virtual background image(s) configured/stored via collaboration content server 106 (in which an image can be referred to herein as ‘content’) can be stored in association with a content identifier (ContentID) and metadata, which can be encrypted (e.g., in a format such as ContentID->(Encrypted Content, Encrypted Metadata), as discussed in further detail herein). When a virtual background image is stored via collaboration content server 106 (and/or third-party content server 116) along with its corresponding metadata, the image can be assigned a corresponding ContentID.

In at least one embodiment, access to virtual background image(s) configured/stored via collaboration content server 106 can be managed through file index service 110, discussed in further detail herein, below. In various embodiments, metadata stored in association with a particular virtual background image can include keyword(s) associated with the image, properties of the image (e.g., name, file size, resolution, type extension, priority/order indication (when multiple images may include the same keyword(s)), user role information (speaker, non-speaker, manager, host, co-host, etc.), user preference scheduling information (e.g., daytime/nighttime, personal, work) or the like.

Transcript generator 112 may be inclusive of any hardware, software, function, logic, system, or the like now known or hereafter developed that may utilize automatic speech recognition (ASR) functionality in order to convert speech/conversion among users 130-1 and 130-2 during a video collaboration session to text in order to generate transcript(s) of the video collaboration session, which can be utilized in accordance with embodiments herein to trigger the dynamic updating or switching of the virtual background image displayed for the video feed of one or more of users 130-1 and/or 130-2 during the video collaboration session. Further, transcript generator 112 may include machine learning (ML) logic 114 that may provide for transcript generator 112 to determine topic(s)/changed topic(s) for a session by analyzing generated transcripts utilizing topic modeling algorithms/functionality now known in the art or hereafter developed. For example, in some instances ASR functionality can be used to convert speech from a video collaboration session to text. Then, a natural language unit (NLU) framework/algorithm, such as MindMeld®, TensorFLow®, etc. and ML modeling algorithms/functionality, such as BERTopic, Top2Vec, spaCy, etc. can be used to determine topic(s)/changed topic(s) for a video collaboration session. MindMeld® is a registered trademark of Cisco Technology, Inc. TensorFlow® and any related marks are registered trademarks of Google Inc.

Broadly during operation of video collaboration system 100, techniques herein provide for the ability to dynamically select/provide a virtual background image for one or more of users 130-1 and/or 130-2 at various times, such as (1) upon initiation of a given video collaboration session based on at least one of scheduling information associated with the video collaboration session and/or a context of the session and also (2) during the video collaboration session based on the context of the session, which can be determined through ASR speech-to-text functionality, as well as intent learning functionality, provided via transcript generator 112/ML logic 114.

The operational flow to facilitate dynamic selection of virtual background images for users can involve managing background images by users 130-1 and 130-2 via their corresponding endpoint devices 132-1 and 132-2 and storing the images in any combination of collaboration content server 106, third-party content server 116, and/or endpoint devices 132-1 and 132-2. Once background images are configured and stored, the images can be utilized through scheduling for a collaboration session, and also during a collaboration session to facilitate dynamic selection, as provided by embodiments herein.

During operation, users 130-1 and 130-2 can set/configure virtual background images utilizing endpoint devices 132-1 and 132-2, respectively for storage via collaboration content server 106 (and/or third-party content server 116, if applicable). Image storage may be configured internal or external to collaboration content server 106.

Virtual background images as discussed for embodiments herein can include any combination of custom images that users can upload via a corresponding endpoint device/collaboration client for storage via video collaboration server 102, which can facilitate storing the images in collaboration content server 106 (and/or third-party content server 116, if applicable) and/or a default list of images that may be provided by the video collaboration server 102. Virtual background images can ‘tagged’ or otherwise provided with one or more keyword(s) or label(s) that can indicate an intent or intents for selecting a particular virtual background image to be displayed for the video stream of a user for or during a video collaboration session.

In an illustrative example, consider that user 130-1, via endpoint device 132-1/collaboration client 134-1, uploads two virtual background images 138-1A and 138-1B utilizing a portal of other user interface (UI) provided via video collaboration server 102 in which the video collaboration server 102 stores the images in collaboration content server 106. The user 130-1 and/or, in some instances, video collaboration server 102 and/or collaboration content server 106 (e.g., via an administrator, collaboration service provider, ML logic provided for the servers, etc.) can tag each image with one or more keyword(s) that reflect the intent regarding when the user may desire that a given image may be selected for being used for or during a given video collaboration session. For example, consider that virtual background image 138-1A may illustrate/show features corresponding to a ‘work’ environment, which the user 130-1 can tag with various keywords, such as ‘work’, ‘office’, ‘cube’, etc. Further, consider that virtual background image 138-1B may illustrate/show features corresponding to a ‘vacation’ environment, which the user 130-1 can tag with various keywords, such as ‘vacation’, ‘fun’, ‘beach’, ‘PTO’ (paid time off), etc. It is to be understood that these example keywords are provided for illustrative purposes only and are not meant to limit the broad scope of the present disclosure.

Tagging of virtual background images may be performed through a variety of mechanisms for both custom images that may be provided/uploaded by a user and/or for default images that may be facilitated via video collaboration server 102. For example, when a given user uploads a custom virtual background image (to collaboration content server 106 or third-party content server 116), the user can tag the image with one or more keyword(s)/intent(s). For embodiments in which multiple virtual background images may have the same set of keyword(s)/intent(s), a user may set an order of preference or priority for selecting each of the images for potential display for the user.

In another example, in some embodiments, tagging may be performed for default images provided by a collaboration service provider, which can be performed manually by the service provider and/or through the user of ML involving supervised learning, such that the video collaboration server 102 and/or logic associated therewith can tag an image with one or more keyword(s)/intent(s) at the time that an image is created and stored. Similar to the user configuration example, noted above, for some embodiments in which the same set of keywords are tagged for multiple images, a preference or priority can also be set for the images.

Although the user-based and service provider-based techniques noted above may be utilized when virtual background images are uploaded or created, in still some embodiments, automatic tagging can be provided for one or more images in order to update keywords for the images based on usage of the images through one or more video collaboration sessions. For example, in some instances, unsupervised learning can be utilized via video collaboration server 102 and/or collaboration content server 106 such that intents may be learned from or during a collaboration session through topic modeling and identifying a set of intents/keywords that may be associated with corresponding virtual background image(s) in use by corresponding user(s), and then adding the identified keywords to the corresponding image(s), as stored via collaboration content server 106.

Regarding the storage of virtual background images, consider various example details through which user privacy can be ensured within video collaboration system 100 via various levels of encryption that can be provided for content stored/accessed via collaboration content server 106 and file index service 110. User privacy features may vary depending on whether a given user is subscribed to/authenticated to utilize collaboration services provided by video collaboration server 102 or whether a given user is not subscribed to/authenticated to utilize such services (e.g., is a guest).

For instances in which a given user is subscribed to/authenticated to utilize collaboration services provided by video collaboration server 102, such as user 130-1, for example, the user can upload multiple custom background images, such as image 138-1A and image 138-1B, to collaboration content server 106 and tag them with one or more keyword(s)/intent(s). The collaboration content server 106 can store each images in an encrypted manner using a key, referred to herein as ‘ContentKey’ that is known only to or associated with an account identifier of the user 130-1. The ContentKey for each image can be stored as part of the metadata for the image.

Apart from an image itself, metadata can also be stored along with the image, which can include the ContentKey, keywords (intents/tags) associated with the image, and any combination of properties of the image, such as name, file size, resolution, type extension, priority/order indication (when multiple images may include the same keyword(s)), user role information (speaker, non-speaker, manager, host, co-host, etc.), user preference information (e.g., daytime/nighttime, personal, work), or the like. The metadata, including the ContentKey, can further encrypted using a MetadataKey.

In various embodiments, the MetadataKey could be an end-to-end (e2e) key utilized by the video collaboration server 102 (e.g., for a collaboration space through which session participants can interact) or could be a user key that is unique to a given user, such that only users participating in a given session may have access to the MetadataKey. The MetadataKey can be encrypted using another key, referred to herein as a MetadataKey encryption key (MetadataKEK).

A corresponding MetadataKEK can be stored along with a corresponding ContentID of each image within the file index service 110. The intents/keywords of each background image itself will be encrypted using a corresponding MetadataKey and can be used to form data for encrypted search indexes stored within file index service 110. Each encrypted file index (encrypted intent/keyword) can point to a corresponding ContentID and MetadataKEK associated therewith, which can be accessible to a given user or, in the case of a collaboration space or an AR/VR space, to all participants in the space. In some instances, the MetadataKEK can be encrypted using user/space keys that can be obtained by collaboration clients (e.g., using a Key Management Service (KMS), or the like).

Any variation of key usage to ensure user/image/metadata/keyword privacy can be envisioned. The example keys describes herein are provided for illustrative purposes only to illustrate how data may be secured in one example, however, other methods/keys for ensuring data privacy can be envisioned.

During a video collaboration session, transcript generator 112 can generate transcripts of the session based on discussions of session users and ML logic 114 can analyze the transcript to identify keywords/intents of the session, which can be sent to collaboration clients 134-1 and 134-2. When a collaboration client for a user, such as collaboration client 134-1/image control logic 136-1 for user 130-1 receives context keywords for a session (e.g., based on updated/changed topics being discussed in the session, etc.), the client 134-1, via image control logic 136-1, can search the encrypted search indexes maintained by the file index service 110 to obtain a pointer to a ContentID and the MetadataKEK corresponding to a given index. For instances in which content may be stored via video collaboration server 102, an entry in the file index service 110 can lead to the MetadataKEK through which metadata and actual content (a virtual background image) can be retrieved and unencrypted via a corresponding MetadataKey, determined by unencrypting the MetadataKEK.

For instances in which a given user is not subscribed to/authenticated to utilize collaboration services provided by video collaboration server 102, the file index service 110 can be used to point to their existing data store, such as third-party content server 116, which can be used to store virtual background images, metadata, etc. in a similar manner. In some instances, such users may authorize their corresponding collaboration client to interact with/obtain data from the third-party content server 116. For example, at the time of joining a video collaboration session, they enter credentials, etc. that allow their collaboration client to obtain images from the third-party content server 116 (e.g., using authorization techniques known in the art, such as Open Authorization (OAuth), or the like).

Accordingly, file index service 110 can store encrypted indexes (keywords) that have been encrypted using user/participant or space keys in which each encrypted index points to a corresponding {ContentID, MetadataKEK}. Context keywords determined, prior to a session, from an agenda/topic information for a session and/or during a session, based on updated topics of conversation, based on determining that a scheduled agenda/topic has changed, or the like, can be used to search the encrypted indexes to determine if the context keywords match any of the stored indexes, which, in turn point to ContentIDs and MetadataKEKs, through which the collaboration content server 106 can be searched.

The collaboration content server 106 can store encrypted metadata and encrypted content for each ContentID such that ContentID->{encrypted Metadata, encrypted Content} in which the encrypted content is a corresponding virtual background image encrypted using a corresponding ContentKey (e.g., Enc(content, ContentKey)) and the metadata includes the tags, properties, and the ContentKey encrypted using a corresponding MetadataKey (e.g., Enc(metadata{tags, properties, ContentKey}, MetadataKey)).

Consider for various examples discussed herein that a ContentID for image 138-1A (138-1A ContentID) and the corresponding encrypted image and metadata (keywords, properties, ContentKey, etc.) can be stored/maintained via collaboration content server 106, as shown at 106(1). Further, consider that a ContentID for image 138-1B (138-1B ContentID) and the corresponding encrypted image and metadata (keywords, properties, etc.) can be stored/maintained via collaboration content server 106, as shown at 106(2).

During operation, once virtual background images and corresponding keywords are configured in the system, suitable virtual background image(s) can be fetched and recommended to a user to determine if the user desires to set their virtual background to a corresponding retrieved image. For example, based on the ContentID and MetadataKEK returned from file index service 110 following a query for a given encrypted search index (an encrypted keyword/intent), the collaboration content server 106 (or third-party content server 116, if applicable) can be queried to obtain one or more virtual background image(s) stored therein.

Similar operations could be performed upon initiation of a given collaboration session such that an agenda or collaboration session subject/title could be analyzed by the collaboration client of a given user in order to identify context keyword(s) for the meeting, user role(s), etc., which could be used to query file index service 110 and collaboration content server 106 in order to select an initial virtual background image for the session. In some instances, scheduling information for the collaboration session could also be used (in addition to and/or in lieu of an agenda) to select an initial virtual background image for the session. For example, in some instances, scheduling information, such as time of day, a session user/participant list, meeting/topic type, etc. could be used to select a corresponding virtual background image for one or more user(s) involved in the session. For example, scheduling information indicative of a group of team members that meet every Friday virtually to have a fun talk before they break for the weekend, could be used to set virtual background images for the users that are more personal/fun, as opposed to more business-like images.

A user can be prompted via a user interface (UI) prompt on their corresponding endpoint device in order to confirm or deny use of a given virtual background image. For example, a user can either provide a positive response to a UI prompt in order to accept use of a particular virtual background image can provide a negative response to the UI prompt in order to deny use of a particular virtual background image at a particular time. For instances in which multiple images may be selected for potential use by a user, multiple UI prompts may be utilized. In the case of an AR/VR room, a host/co-host may be prompted with a selected background image and can accept the selection, in which the virtual background image can be set for all participants of the AR/VR room to experience. In some instances, responses to UI prompts can be used to learn user intents for different collaboration sessions, which can be used to further inform future selections, update keyword(s) for images, etc. For example, past session intents/keywords and background images selected for those intents/keywords can be used to suggest similar background images to a user when the probability of the intent of a current session (e.g., as determined from an agenda for the session, etc.) matches one or more intents of a past meeting.

As noted above, embodiments herein provide that a virtual background image can be dynamically selected/provided for one or more of users 130-1 and/or 130-2 at various times, such as (1) upon initiation of a given video collaboration session based on at least one of scheduling information associated with the video collaboration session and/or a context of the session and also (2) during the video collaboration session based on the context of the session, which can be determined through ASR speech-to-text functionality, as well as intent learning functionality, provided via transcript generator 112/ML logic 114.

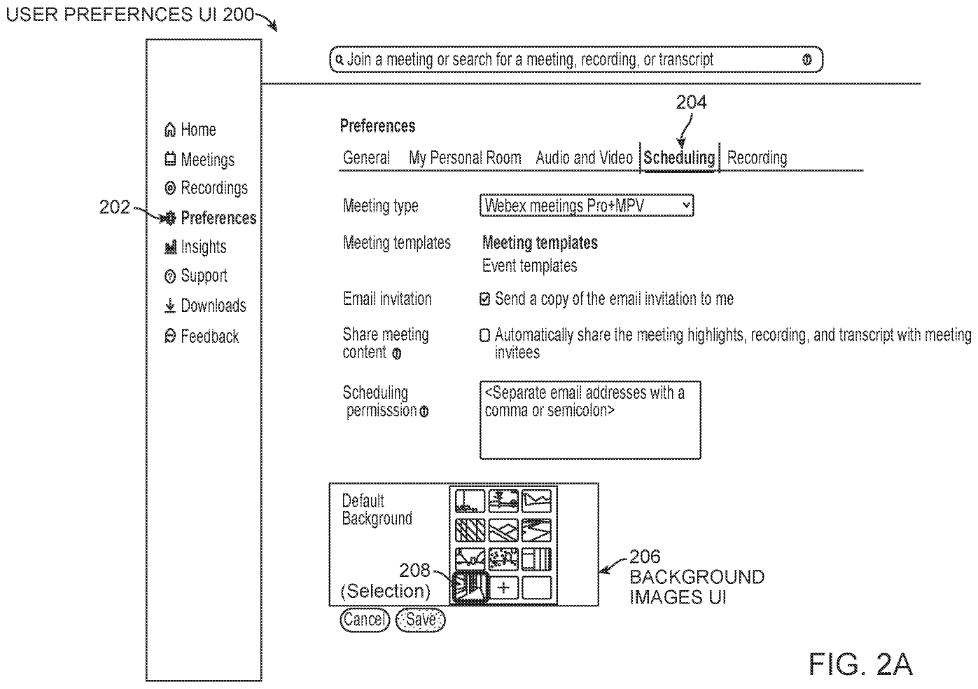

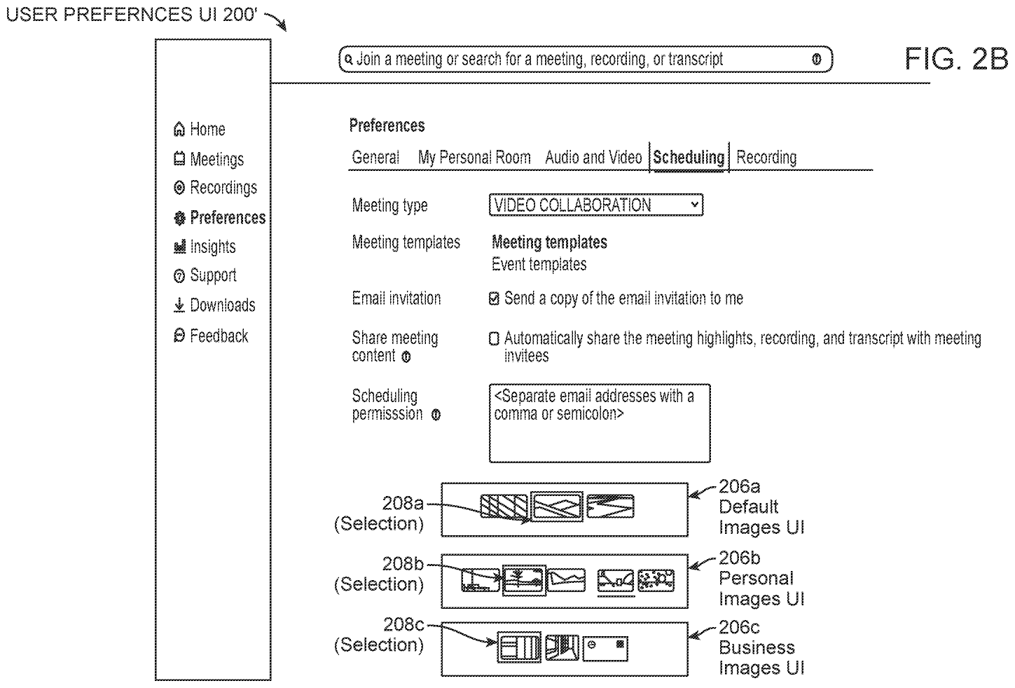

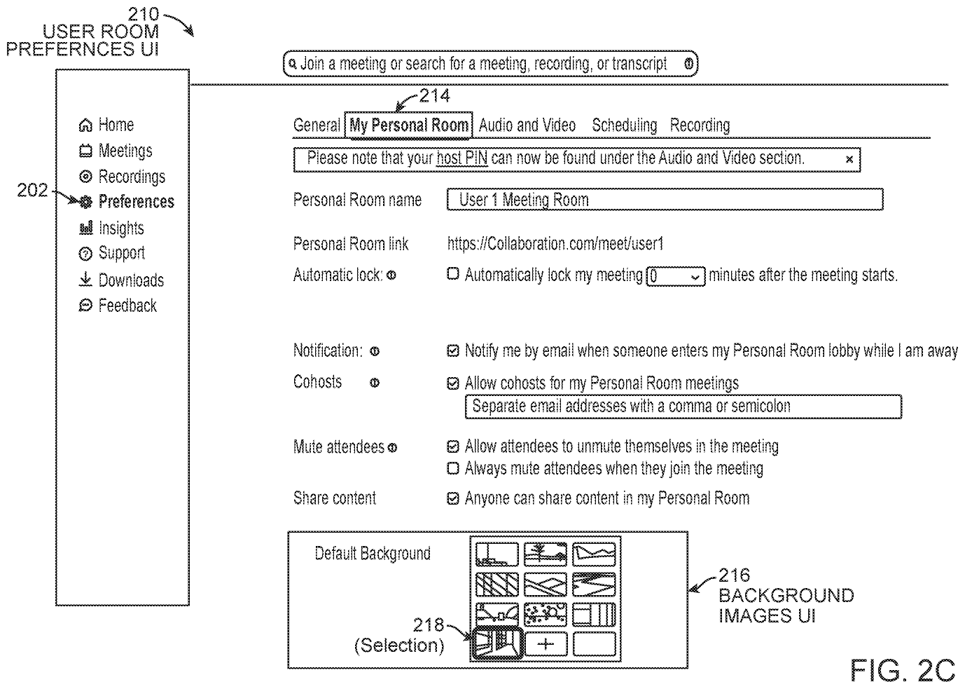

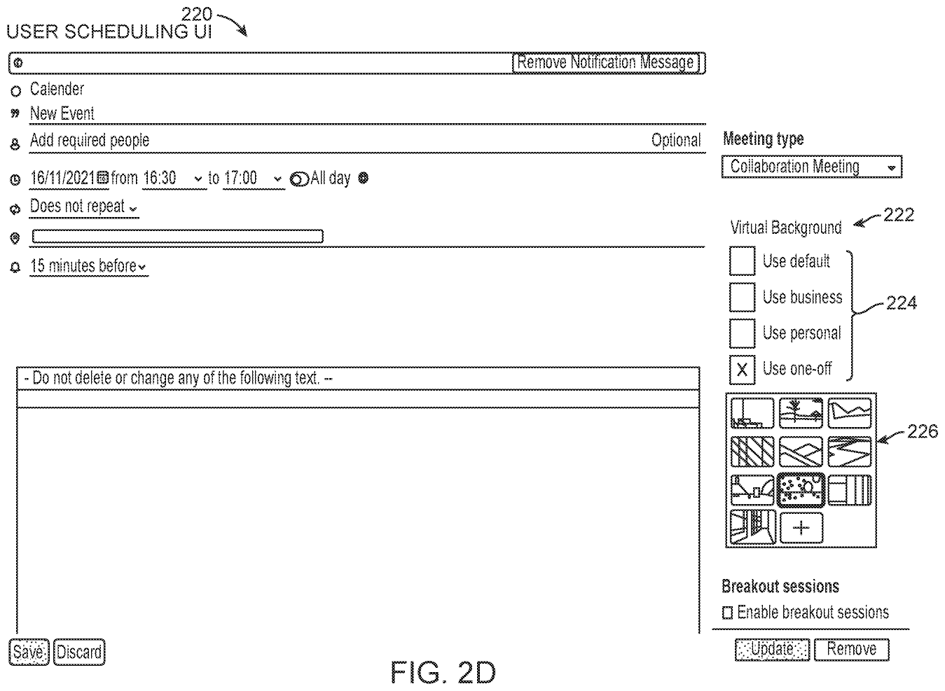

Referring to FIGS. 2A, 2B, 2C, and 2D, FIGS. 2A-2D illustrate various example user interfaces that may be utilized for providing virtual background image user preference(s) associated with scheduling information for video collaboration sessions. For example, in some instances, an initial virtual background image can be selected/set for a video collaboration session based on user preference(s) associated with various scheduling information provided and stored via video collaboration server 102 and/or collaboration client(s) 132-1/132-2 for user(s) 130-1/130-2 that are to participate in a given video collaboration session. The selection of an initial virtual background image can be based on any combination of user preference(s) associated with scheduling information for a session and/or tags/keywords, etc. stored in association with virtual background image(s) that can be retrieved using the techniques described herein via file index server 110/collaboration content server 106.

Per-session scheduling information 104 can be stored that indicates day/time information for a session, agenda/subject information for the session, role information for users participating in the session, user preference(s) for users participating in the session, etc. As illustrated in FIG. 1, a first session (Session 1) can be scheduled by user 130-1 in which scheduling information, labeled 104(1), for the first session can be stored via video collaboration server 102 and/or in some instances, can also be stored via collaboration client 134-1 (e.g., for integration with a calendar/scheduling application operated via endpoint device 132-1), as well as via other collaboration clients for users that may be participating in the session (e.g., collaboration client 134-2, if user 130-2 is participating in the session).

In one embodiment, a user may set, via user scheduling preferences, one or more virtual background image(s) that can be used for different times of the day. For example, the user may select one or more first virtual background image(s) that can be utilized from 7:00 AM to 6:00 PM for work/daytime background(s) and may select one or more second virtual background image(s) that can be utilized from 6:00 PM to 7:00 AM for non-work/personal/nighttime background(s).

In another embodiment, a user may set, via user scheduling preferences, one or more virtual background image(s) that can be used depending on whether a collaboration session is a personal session or a work session. In yet another embodiment, a user may set, via user scheduling preferences, one or more virtual background images that can be used depending on whether a collaboration session is for one particular client versus another client. In yet another embodiment, a user may set, via room preferences, one or more virtual images that can be used depending on whether a collaboration session is to be hosted via a user's personal room or via a common meeting space. Other variations/preferences can be envisioned.

User scheduling preferences could be configured via one or more settings or preferences user interfaces (UIs) through which scheduling information can be configured for a given user. For example, FIG. 2A illustrates an example preferences UI 200 through which a user can indicate virtual background image preferences. For example, a ‘Preferences’ UE element 202 could be selected, within which a ‘Scheduling’ UI element 204 could be selected, through which a user could select (208), via a background images UI 206, one or more images that could be used in different scenarios. For example, as shown in FIG. 2A, a user can select one or more images that may be utilized as a ‘Default’ virtual background image.

In some embodiments, a background images UI may be divided into multiple UIs to enable a user to select one of more virtual background images that can utilized for different types of video collaboration sessions. For example, FIG. 2B illustrates another example preferences UI 200′ through which a user can indicate virtual background image preferences, in accordance with at least one embodiment. As illustrated in FIG. 2B, a number of background image UIs can be provided, such as a ‘Default Images’ UI 206a (through which a user can select (208a) one or more default images that may be utilized for a video collaboration session that may not be designated as a personal or work-related session), a ‘Personal Images’ UI 206b (through which a user can select (208b) one or more personal or non-work images that may be utilized for a personal video collaboration session), and a ‘Business Images’ UI 206c (through which a user can select (208c) one or more work/business-related images that may be utilized for a work/business-related video collaboration session).

The examples illustrated in FIG. 2B are provided for illustrative purposes only and are not meant to limit the broad scope of the present disclosure. For example, in some scenarios, a background images UI could be further divided into client specific categories, such as ‘Client 1’ and ‘Client 2’, time specific categories such as ‘Daytime/Day’ and ‘Nighttime/Night’, and/or the like through which a user could select corresponding images based on the type of collaboration session that is to be initiated, the audience/participants of the session, time of day, etc. In one instance, the preferences set by the user can be stored within scheduling information for a given video collaboration session scheduled by the user (e.g., user preferences, as illustrated for the first session scheduling information 104(1)).

FIG. 2C illustrates another example preferences UI 210 through which a user can indicate other virtual background image preferences. For example, the Preferences UE element 202 could be selected, within which a ‘My Personal Room’ UE element 214 could be selected, through which a user could select (218) via a background images UI 216, a default virtual background image to be utilized for sessions involving the user's personal room. The preferences set by the user can be stored within scheduling information for a given video collaboration session scheduled by the user (e.g., user preferences, as illustrated for the first session scheduling information 104(1)). In some embodiments, background images UI 216 may be divided into multiple UIs as described above in relation to FIG. 2B.

In accordance with embodiments herein, it may also be useful to provide users with the ability to choose a virtual background image that can be used for a session when scheduling the session via additional UI elements. FIG. 2D illustrates an example user scheduling UI 220 through which a user can indicate other virtual background image preferences. For example, within the user scheduling UI 220, a Virtual Background UI element 222, may enable a user to select meeting background image preferences via image type UI elements 224 (e.g., default, business, personal, one-off, etc.), and, in some instances, may enable the user to select a corresponding virtual background image to be utilized via a background images UI 226. For example, if the user selects a ‘one-off’ UI element, as shown in FIG. 2D, the user can select an image to use for the one-off session scenario via the background images UI 226. Otherwise, the virtual background image can be selected based on other settings configured by the user, such as those discussed for FIGS. 2A and 2B, above, involving default images, personal meeting images versus business meeting images, or the like. The preferences set by the user can be stored within scheduling information for a given video collaboration session scheduled by the user (e.g., user preferences, as illustrated for the first session scheduling information 104(1)).

In some embodiments, an image selection within the background images UI 226 may be auto-selected for a user based on a previous selection by the user for a given meeting type. For example, a default option that could be auto-selected for a user to avoid the user having to make a selection every time a session is scheduled, in addition to specific choices that may be set by the user in the scheduling UI 220 for a particular session. Such a feature may be useful for instances in which a majority of a user's scheduled meetings may utilize the same background image, but occasionally the user may select a different background image.

As noted previously, a user can be prompted, via a user interface (UI) prompt, in order to provide an input via their corresponding endpoint device that indicates either that the user accepts or denies use of a particular virtual background image at a particular time. In some instances, the UI prompt provided to a user at the start of a session could remind the user to check their virtual background, with a suggestion for which virtual background might be more appropriate. For example “You are about to use your ‘work’ background but this looks like a personal meeting. Would you like to swap to your ‘personal’ background?” or “You are about to use your ‘daytime’ background but it is already dark outside. Would you like to swap to your ‘nighttime’ background?”

Aside from scheduling preferences, in still some embodiments, a user may select different virtual background images that may be desired for use under different lighting conditions, as prescribed at least by commonly assigned U.S. patent application Ser. No. 17/010,333, entitled “Matching Foreground and Virtual Background During a Video Communication Session,” filed on Sep. 2, 2020, which application is incorporated by reference herein in its entirety. For such embodiments, a camera for a user's endpoint device may detect the lighting conditions and, based on the detected conditions, the collaboration client could select a corresponding virtual background image for use according to the user's stored preferences.

Aside from dynamic virtual background image selection for a user for a video collaboration session, embodiments herein may also be extended to facilitate virtual background image selection for multiple users that may be involved in immersive sessions, such as AR/VR video session. For example, in a VR room including multiple users, the background for the room may be dynamically change via the host/co-host meeting client as a session progresses, based on different topics being discussed.

In another example, a pre-curated agenda could be used to switch background images as the topics change (e.g., at times as designated in the agenda). Consider an example involving an online class in which the virtual background image for all class participants can automatically change for each class period in the VR room that all participants have joined (e.g., when a Science class starts a virtual background image illustrating a living organism can be shown, when a Social Studies class starts and the teacher is discussing history, corresponding historical images can be shown in the background).

In another example, an individual participant's virtual background image may be changed depending on the role that the participant has at a particular point in a video collaboration session. For example, in a VR classroom, a particular student may have a role that involves presenting a report or reading a chapter, such that the student's virtual background image can be changed based on the student's changed role.

Such techniques can also be extended to pre-planned AR/VR business meetings such that any combination of topics discussed and/or speaker's presenting for a given meeting can be used to trigger changing the virtual background image for one or more participants. For example, in many pre-planned meetings (e.g., training sessions, tech talks, all-hands meetings, shareholder meetings, etc.) there will be pre-planned content/speakers scheduled for different time slots. During an AR/VR session, as speakers/topics switch, the virtual background image in the room can be dynamically changed. Changes could also be triggered for individual participants based on the role that they may have at a given point in time for a meeting. For example, participants may play different roles in a meeting at different times (e.g., observer/listener, presenter, moderator, question/answer facilitator, coordinator, etc.) such that virtual background images for individual participants can be changed according to the participant's changed role(s) during a meeting.

In some embodiments, techniques herein could also be extended to changing the background of animated virtual avatars and/or changing a virtual avatar itself for a given participant of a for AR/VR session. For example, depending on the role of participant at a given point in time during a session, a virtual background image for a virtual avatar and/or the virtual avatar itself of the participant could be dynamically changed based on the current role of the participant (e.g., moderator, scrum master, coordinator, presenter, observer/listener, etc.).

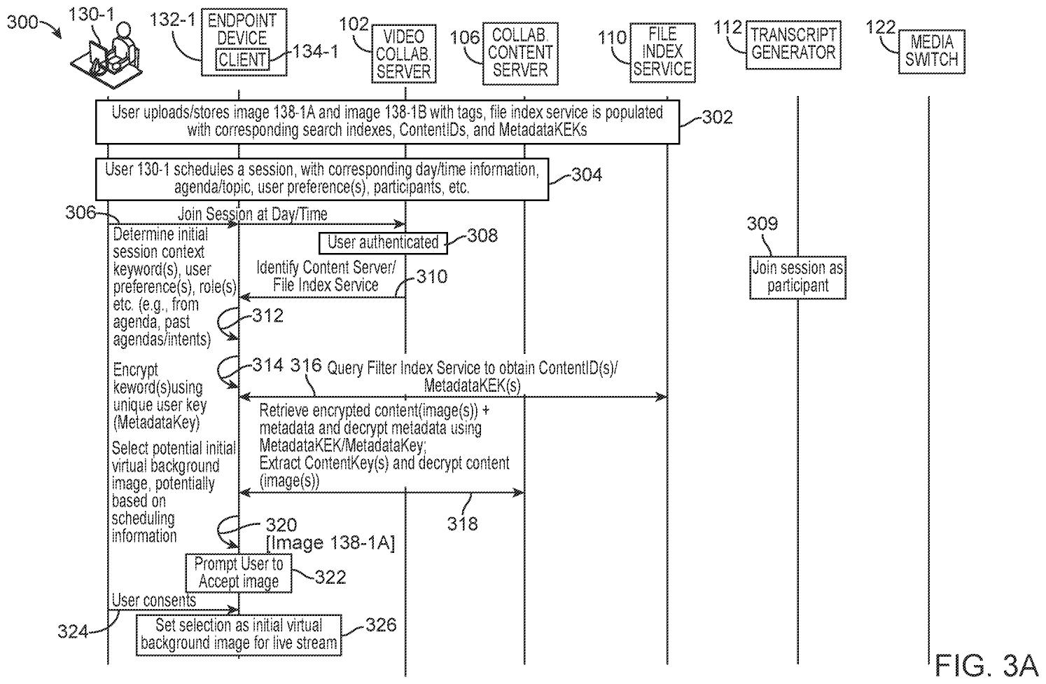

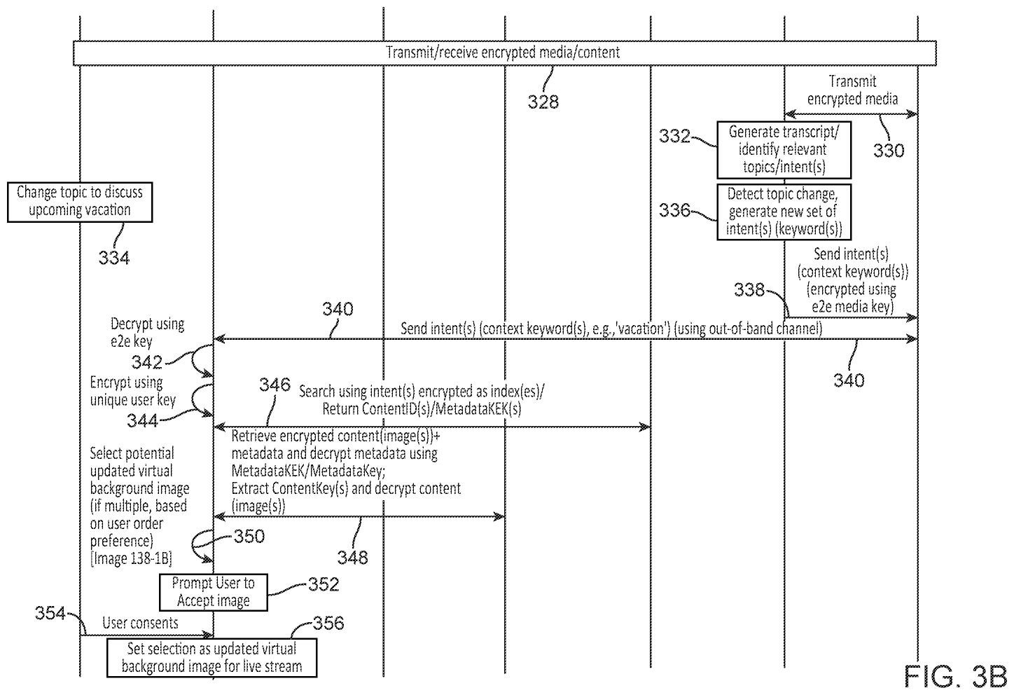

Consider an operational example through which dynamic virtual background image selection can be provided for user 130-1, as illustrated in FIGS. 3A and 3B, which are a message sequence diagram illustrating a call flow 300 through which virtual background images can be selected and displayed for a video collaboration session involving user 130-1, according to an example embodiment. FIGS. 3A and 3B include user 130-1, endpoint device 132-1, including collaboration client 134-1, video collaboration server 102, transcript generator 112, file index service 110, and collaboration content server 106. Image control logic 136-1 and ML logic 114 are not shown in FIGS. 3A and 3B, but may be discussed with reference to various operations described herein, below.

As shown at 302, consider that user 130-1, via endpoint device 132-1/collaboration client 134-1/image control logic 136-1 uploads/stores virtual background images 138-1A and 138-1B and tags the images with one or more intents/keywords via video collaboration server 102 through which the images and related information can be stored to collaboration content server 106. For example, consider that user 130-1 tags image 138-1A with the keywords ‘office’, ‘work’, ‘default’, etc. and also tags image 138-1B with keywords ‘vacation’, ‘fun’, ‘beach’, etc. Based on the uploading/storing of the images, ContentIDs are generated for the images, metadata is generated for the images (e.g., based on the tags, etc.), the images and metadata are encrypted, and the file index service 110 is populated with encrypted search indexes, each corresponding to a keyword associated with each image, and pointing to the ContentID and MetadataKEK for each image, also at 302.

At 304, consider that user 130-1, via endpoint device 132-1/collaboration client 134-1 schedules a video collaboration session via video collaboration server 102 in which scheduling information for the session includes day/time information for the session, an agenda and/or topic information for the session, user preference(s) (e.g., as discussed above for FIGS. 2A-2C, etc.), session participant information, and/or the like. The scheduling information can be stored across any combination of video collaboration server 102 and/or endpoint device 132-1/collaboration client 134-1 of user 130-1.

Thereafter, consider at 306 that user 130-1, via endpoint device 132-1/collaboration client 134-1 joins the session at the given day/time and that the video collaboration server 102 authenticates the user/client, as shown at 308, to join the session (e.g., using a username, password, and/or any other authentication credential(s) for the user/client). Although FIG. 3A illustrates an embodiment in which user 130-1 joins the video collaboration session via endpoint device 132-1/client 134-1, it is to be understood that the user can join the session from any device/client configured to communicate with video collaboration server 102 (e.g., a mobile device having an application installed thereon to communicate with the video collaboration server 102, etc.). At 309, consider that transcript generator 112 joins the video collaboration session as a participant. The transcript generator 112 can represent any transcript generation service hosted alongside the video collaboration server 102. In one example, when the session host/co-host (e.g., user 130-1) enables captions/transcription for a session, the session controller (e.g., video collaboration server 102) can invite the transcript generator 112 to join as a participant to the session. In another example, when the session is scheduled, the host/co-host can indicated a transcription service associated with transcript generator 112 to be utilized for the session. Thereafter, when the session is started, the session controller can invite the transcript generator 112 to join the session as a participant. In yet another example for a WebEx-based solution, a locus (meeting controller) can invite a service, referred to as a VMC (Voicea Meeting Client), to JOIN the meeting bridge as a participant. In turn, the VMC will join the meeting, obtain audio for the meeting, send the audio to a Voicea speech-to-text (STT) service, obtain a transcript from the STT service, and send transcript via a low latency link/out-of-band channel back to the collaboration client 134-1 (as noted at 340, below).

Upon authentication of the user/client, the video collaboration server 102 can identify the collaboration content server 106 and the file index service 110 to the video collaboration client 134-1, as shown at 310, which can enable the collaboration client 134-1 to retrieve/download one or more images via interactions with file index service 110 and collaboration content server 106. In at least one embodiment, video collaboration server 102 can provide an Internet Protocol (IP) address (e.g., IP version 4 (IPv4) address or IP version 6 (IPv6) address) for each of the collaboration content server 106 and file index service 110.

At 312, the collaboration client 134-1, via image control logic 136-1, can determine one or more initial session context keyword(s), user preference(s) based on scheduling information for the session, participant role(s), etc. from the agenda for the session, and/or, in some instances, information learned from past/previous agenda(s)/intents learned therefrom. In one example, collaboration client 134-1/image control logic 136-1 can perform artificial intelligence (AI)/ML natural language unit (NLU) processes on the agenda/topic information for the session in order to identify appropriate dictionaries, etc. that can be used to identify initial context keywords for the session. For example, based on such analysis, consider for that collaboration client 134-1, via image control logic 136-1 determines that a topic/intent for the session relates to ‘work’, which is the context keyword used to search into file index service 110.

As shown at 314, collaboration client 134-1, via image control logic 136-1, encrypts the initial context keyword ‘work’ using a unique key, such as MetadataKey, and then queries the file index service 110 using the encrypted initial context keyword, as shown at 316, in which the file index service 110 returns the ContentID corresponding to virtual background image 138-1A (138-1A ContentID) and the corresponding MetadataKEK stored for the index. In some embodiments, other related information, such as a participant list, past meeting agendas and/or transcripts involving the participants/topics, user preference(s) based on scheduling information, etc. can be used to inform the query. Use of past meeting agendas/transcripts may be useful for use cases involving recurring meetings, such as daily standups, weekly catch-ups, daily classrooms, etc.

As shown at 318, the collaboration client 134-1, via image control logic 136-1, can retrieve the encrypted image metadata (keywords, properties, ContentKey) stored for the 138-1A ContentID and can decrypt the metadata using the MetadataKEK, which can be unencrypted using the user/space keys to obtain the MetadataKey. Using the MetadataKey to unencrypt the metadata, the collaboration client 134-1, via image control logic 136-1, obtains the ContentKey, which is then used to unencrypt the encrypted virtual background image 138-1A. It is to be understood that the operations at 316 and 318 can be performed iteratively for multiple context keyword(s) that may initially be determined for a video collaboration session.

At 320, the collaboration client 134-1, via image control logic 136-1, can select a potential initial virtual background image for the user 130-1 to initially utilize for the video collaboration session. If multiple images are determined, for example, based on multiple ContentIDs being returned from one or more file index service 110 search queries, the collaboration client 134-1, via image control logic 136-1, can inspect user order preferences for the multiple images to determine a potential initial virtual background image to select for the user 130-1 and/or, in some instances, can select an image having the most keywords that match a maximum number of context keywords for the session.

Still further, user preference(s) based on scheduling information can be used to influence selection of the initial virtual background image, in some embodiments. For example, user preference(s) associated with scheduling information obtained/stored for the session (e.g., as discussed for FIGS. 2A-2C) by collaboration client 134-1 can be used to select a potential initial virtual background image for the user 130-1 (e.g., based on day/time user preference set by the user, room preferences, whether the session is a personal session or a work-related session, etc.), which could be selected from among multiple images returned from file index service lookups and/or could be a different virtual background image selected based on the user preference(s) associated with the scheduling information for the session. Other variations can be envisioned. For example, in still some instances, the initial virtual background image could be selected based on user preference(s) associated with selecting an image based on light/dark lighting conditions detected by a camera of endpoint device 132-1 for the environment in which user 130-1 is attending the session.

For the embodiment of FIGS. 3A-3B, consider that only one virtual background image is selected at 320, virtual background image 138-1A. At 322, based on the selection, the collaboration client 134-1, via image control logic 136-1 and endpoint device 132-1, prompts the user 130-1, via a UI prompt, to allow the user 130-1 to accept/consent to using the initial virtual background image 138-1A for the start the video collaboration session.

In one embodiment, the UI prompt provided to user 130-1 via endpoint device 132-1 may display a thumbnail image of the virtual background image 138-1A to enable the user 130-1 to confirm which image is being selected. In one embodiment, as noted above, a message may be displayed to the user 130-1, such as “You are about to use your ‘work’ background but this looks like a personal meeting. Would you like to swap to your ‘personal’ background?” or other message to confirm the user's intent to use a particular image. At 324, consider that the user 130-1 consents to using the initial virtual background image 138-1A (e.g., provides a positive response to allow the image to be used, as opposed to a negative response not allowing the image to be used) and, based on the user 130-1 consent, virtual background image 138-1A is used for the video feed/stream involving user 130-1, as shown at 326. In some instances, such user feedback can be used to fine-tune selections for the user (e.g., using AI/ML logic to learn user preference(s) in different instances.

Continuing to FIG. 3B, consider that, as the meeting progresses, encrypted media (e.g., audio) and content (e.g., video) involving the live audio/video stream for the session are communicated between the endpoint device 132-1, media switch 122, video collaboration server 102, and other users involved in the video collaboration session, as shown at 328. As shown at 330, media switch 122 forwards the encrypted media (live stream) to transcript generator 112, which can decrypt the encrypted media (e.g., using e2e media keys), and can utilize ASR functionality and ML logic 114 to generate transcripts (332) of the live stream and identify relevant topics/intents of discussions among user 130-1 and other users participating in the video teleconference session (e.g., using topic modeling and/or any other techniques now known in the art or hereafter developed).

At 334, consider that user 130-1 changes the topic for the session in order to discuss plans for an upcoming vacation. At 336, consider that transcript generator 112/ML logic 114 detects the topic change and generates a new set of intent(s)/context keyword(s) for the session, which can be encrypted (e.g., using e2e media keys) and sent to media switch 122, at 338, which sends the detected intent(s)/context keywords to endpoint device 132-1/collaboration client 134-1 (and other endpoint devices/collaboration clients of other users for the session) via an out-of-band channel, as shown at 340. In at least one embodiment, the out of band channel may be a low latency link, such as a Mercury Systems® fabric. Mercury Systems® is a registered trademark of Mercury Systems, Inc. Consider, for example, that at least one context keyword detected for the session, based on the discussion, is ‘vacation’.

As shown at 342, collaboration client 134-1, via image control logic 136-1, decrypts the context keyword(s) using the e2e media key and re-encrypts the context keyword, as shown at 344, using the unique user key (e.g., MetadataKey). As shown at 346, collaboration client 134-1, via image control logic 136-1, queries the file index service 110 using the encrypted context keyword. For the query utilizing ‘vacation’, encrypted using the user key, consider that the file index service 110 returns the ContentID corresponding to virtual background image 138-1B (138-1B ContentID) and the corresponding MetadataKEK stored for the index.

As shown at 348, the collaboration client 134-1, via image control logic 136-1, can retrieve the encrypted image metadata (keywords, properties, ContentKey) stored for the 138-1B ContentID and can decrypt the metadata using the MetadataKEK, which can be unencrypted using the user/space keys to obtain the MetadataKey. Using the MetadataKey to unencrypt the metadata, the collaboration client 134-1, via image control logic 136-1, obtains the ContentKey for the image, which is then used to unencrypt the encrypted virtual background image 138-1B. It is to be understood that the operations at 346 and 348 can be performed iteratively for multiple context keyword(s) that may initially be determined for a video collaboration session.

At 350, the collaboration client 134-1, via image control logic 136-1, can select a potential updated virtual background image for the user 130-1 to utilize for the ongoing video collaboration session. If multiple images are determined, for example, based on multiple ContentIDs being returned from one or more file index service 110 search queries, the collaboration client 134-1, via image control logic 136-1, can inspect user order preferences for the multiple images to determine a potential initial virtual background image to select for the user 130-1 and/or, in some instances, can select an image having the most keywords that match a maximum number context keywords for the session.

For the embodiment of FIGS. 3A-3B, consider that only one virtual background image is selected at 350, virtual background image 138-1B. At 352, based on the selection, the collaboration client 134-1, via image control logic 136-1 and endpoint device 132-1, prompts the user 130-1, via a UI prompt, to allow the user 130-1 to accept/consent to using the virtual background image 138-1B for use in the ongoing video collaboration session. In one embodiment, the prompt provided to user 130-1 via endpoint device 132-1 may display a thumbnail image of the virtual background image 138-1B to enable the user 130-1 to confirm which image is being selected. In one embodiment, a message may be displayed to the user 130-1, such as “You are about to use a custom background but this looks like a work meeting. Would you like to keep your current background or update to the selected?” or other message to confirm the user's intent to use the updated virtual background image. At 354, consider that the user 130-1 consents to using the initial virtual background image 138-1A (e.g., provides a positive response to allow the image to be used, as opposed to a negative response not allowing the image to be used) and, based on the user 130-1 consent, virtual background image 138-1A is used for the video feed/stream involving user 130-1, as shown at 356.

Accordingly, technique herein provide for the ability to utilize intents/context keywords determined/detected for a video collaboration session, in combination with topic modeling or other similar ML techniques in order to select virtual background image(s) for users involved in video collaboration sessions. In some instances, the techniques can be enhanced to select background images based on previously used background images that were selected for similar or the same conversations involving a same topic, a same group of participants, etc.

It is to be understood that techniques illustrated for FIGS. 3A and 3B can be enhanced to AR/VR collaboration sessions, as discussed herein, such that VR room background images could also be set/updated based on topics determined or changed for the session (e.g., changing subjects/class periods for an online classroom, etc.).

In still some instances, such techniques could also be utilized to modify backgrounds for virtual avatars and/or for changing virtual avatars of users themselves. For example, in one instance, virtual avatars/virtual avatar backgrounds could be stored in collaboration content server 106 and used populate indexes of file index service 110 in a similar manner as virtual background images, such that a virtual avatar and/or virtual avatar background could be provided for user 130-1 in the video collaboration session based on an initial or updated context keyword for the session and corresponding file index server 110/collaboration content server 106 lookups.

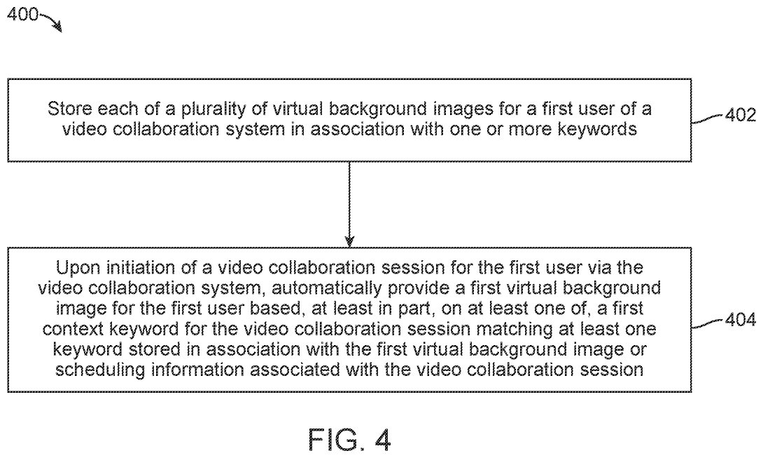

Referring to FIG. 4, FIG. 4 is a flow chart depicting a method 400 according to an example embodiment. In at least one embodiment, method 400 illustrates example operations that may be performed, at least in part by a video collaboration client of a user endpoint device (e.g., endpoint device 132-1/collaboration client 134-1) in order to facilitate dynamic virtual background image selection for a video collaboration session of the user, according to an example embodiment.

At 402, the method may include storing each of a plurality of virtual background images for a first user of a video collaboration system in association with one or more keywords. For example, user 130-1, via endpoint device 132-1/collaboration client 134-1 can upload custom images via a portal/UI provided via video collaboration server 102 and tags the images with one or more keywords, user preferences, properties, and/or the like (e.g., metadata), such that the video collaboration server 102 facilitates storing the images and metadata for the images in an encrypted manner in collaboration content server 106, as well as populating file index service 110 with corresponding encrypted keywords and ContentID/MetadataKEK information.

At 404, the method may include, upon initiation of a video collaboration session for the first user via the video collaboration system, automatically providing a first virtual background image for the first user based, at least in part, on at least one of, a first context keyword for the video collaboration session matching at least one keyword stored in association with the first virtual background image or scheduling information associated with the video collaboration session. For example, in at least one embodiment the method may include the endpoint device 132-1/collaboration client 134-1 querying file index service 110 using the context keyword (or encrypted context keyword) in order to obtain a content identifier (ContentID) corresponding to the first virtual background image. Based on the content identifier, the endpoint device/collaboration client 134-1 can query the collaboration content server 106 (or third-party content server 116) to obtain the first virtual background image and metadata (keywords, properties, user preferences, etc.) from the collaboration content server 106. In some embodiments, the image and metadata can be encrypted and the collaboration client 134-1 can unencrypt the image and metadata utilizing techniques as discussed herein.

In at least one embodiment, the first context keyword can be determined based on one or more words determined from an agenda of the video collaboration session; one or more words for at least one past agenda for at least one previous video collaboration session; at least one role indication of the first user (e.g., host, presenter, manager, etc.).

In some embodiments, the providing can include selecting the first virtual background image from multiple potential virtual background images based on a priority or user preference of the first virtual background image indicating that is preferred to be used over other potential virtual background images. In at least one embodiment, the method may include obtaining a confirmation from the user (e.g., a positive response provide by the user via a UI prompt provided to the user) to utilize the first virtual background image for the video collaboration session such that, based on the confirmation, the collaboration client sets/displays the first virtual background image as the virtual background for the users live stream. In some instances, if the user does not confirm use of the first virtual background image (e.g., a negative response provided by the user), the collaboration client can set/display a second virtual background image as the virtual background for the users live stream or can suggest one or more other virtual background image(s) to the user, which may similarly be confirmed/rejected by the user using similar prompt/response processes.

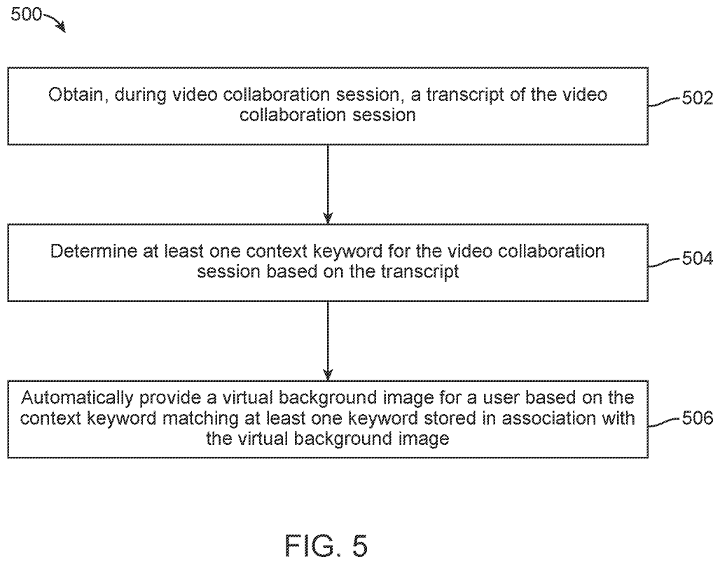

Referring to FIG. 5, FIG. 5 is another flow chart depicting another method 500 according to an example embodiment. In at least one embodiment, method 500 illustrates example operations that may be performed, at least in part, by a transcript generator (e.g., transcript generator 112) and a video collaboration client of a user endpoint device (e.g., endpoint device 132-1/collaboration client 134-1) in order to facilitate dynamic virtual background image selection for a video collaboration session of the user, according to an example embodiment.

As illustrated at 502, the method may include obtaining, during video collaboration session, a transcript of the video collaboration session (e.g., generating/obtaining a transcript by transcript generator 112, based on conversation among participants during the session).

At 504, the method may include determining a context keyword for the video collaboration session based on the transcript (e.g., based on topic modeling performed via ML logic configured for transcript generator 112).

At 506, the method may include automatically providing a second virtual background image for a user (e.g., user 130-1) based on the context keyword matching at least one keyword stored in association with the second virtual background image. For example, in at least one embodiment the method may include the endpoint device 132-1/collaboration client 134-1 querying file index service 110 using the context keyword (or encrypted context keyword) in order to obtain a content identifier (ContentID) corresponding to the first virtual background image. Based on the content identifier, the endpoint device/collaboration client 134-1 can query the collaboration content server 106 (or third-party content server 116) to obtain the first virtual background image and metadata (keywords, properties, user preferences, etc.) from the collaboration content server 106. In some embodiments, the image and metadata can be encrypted and the collaboration client 134-1 can unencrypt the image and metadata utilizing techniques as discussed herein.

In some embodiments, the providing can include selecting the first virtual background image from multiple potential virtual background images based on a priority or user preference of the first virtual background image indicating that is preferred to be used over other potential virtual background images. In at least one embodiment, the method may include obtaining a confirmation from the user (e.g., a positive response provide by the user via a UI prompt provided to the user) to utilize the first virtual background image for the video collaboration session such that, based on the confirmation, the collaboration client sets/displays the first virtual background image as the virtual background for the users live stream. In some instances, if the user does not confirm use of the first virtual background image (e.g., a negative response provided by the user), the collaboration client can set/display a second virtual background image as the virtual background for the users live stream or can suggest one or more other virtual background image(s) to the user, which may similarly be confirmed/rejected by the user using similar prompt/response processes.

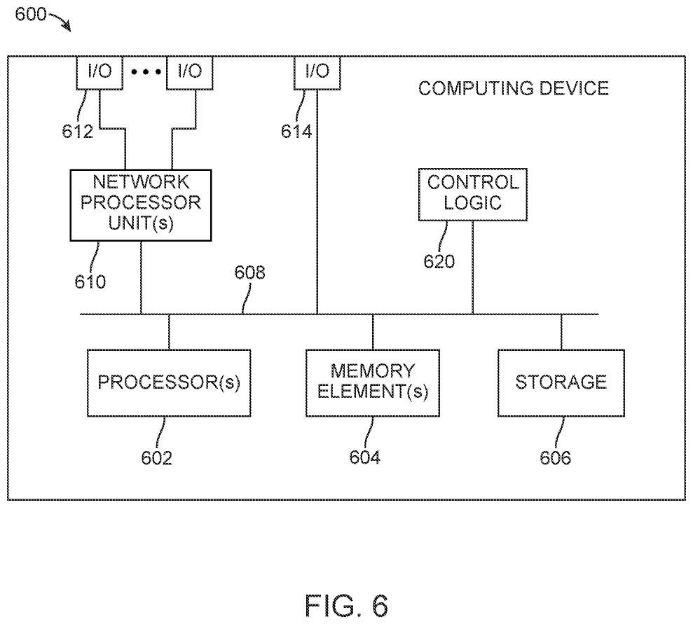

Referring to FIG. 6, FIG. 6 illustrates a hardware block diagram of a computing device 600 that may perform functions associated with operations discussed herein. In various embodiments, a computing device or apparatus, such as computing device 600 or any combination of computing devices 600, may be configured as any entity/entities as discussed herein in order to perform operations of the various techniques discussed herein, such as, for example, any of endpoint device 132-1, endpoint device 132-1, video collaboration server 102, collaboration content server 106, transcript generator 112, file index service 110, media switch 122, and/or any other network element/device/etc. discussed for embodiments herein.

In at least one embodiment, computing device 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620 (e.g., image control logic). In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., hardware processor(s)) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communications (wired and/or wireless) between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, and/or any other I/O port(s) and/or antennas/antenna arrays now known or hereafter developed. Thus, the network processor unit(s) 610 and/or network interface(s) 612 may include suitable interfaces for receiving, transmitting, and/or otherwise communicating (in a wired and/or wireless manner) data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620 of computing device 600) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, and register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) (e.g., memory element(s) 604 of computing device 600) and/or storage (e.g., storage 606 of computing device 600) can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include storing each of a plurality of virtual background images for a first user of a video collaboration system in association with one or more keywords; and upon initiation of a video collaboration session for the first user via the video collaboration system, automatically providing a first virtual background image for the first user based, at least in part, on at least one of, a first context keyword for the video collaboration session matching at least one keyword stored in association with the first virtual background image or scheduling information associated with the video collaboration session.

In one instance, the method may further include providing a user interface prompt to allow the first user to confirm whether the first virtual background image is to be utilized for the video collaboration session; and setting one of: the first virtual background image for the first user for the video collaboration session based on obtaining a positive response to the user interface prompt; or a second virtual background for the first user for the video collaboration session based on obtaining a negative response to the user interface prompt. In one instance, the first virtual background image is provided for one or more other users associated with the video collaboration session.

In one instance, the scheduling information includes at least one of: a day indication; a time indication; or an indication identifying whether the video collaboration session is a personal session or a work-related session.

In one instance, the method may further include determining the first context keyword based on at least one of: one or more words contained in an agenda of the video collaboration session; one or more words contained in at least one past agenda of at least one previous video collaboration session; or at least one role indication of the first user.

In one instance, the method may include obtaining, during the video collaboration session, a transcript of the video collaboration session; determining a second context keyword based on the transcript; and automatically providing a second virtual background image for the first user based on the second context keyword matching at least one keyword stored in association with the second virtual background image. In one instance the method may include obtaining a second context keyword based on a transcript of the video collaboration session; and automatically providing a second virtual background image for the first user based on the second context keyword matching at least one keyword stored in association with the second virtual background image. In one instance, the method may further include providing a user interface prompt to allow the first user to confirm whether the first virtual background image is to be utilized for the video collaboration session; and the second virtual background image for the first user for the video collaboration session based on obtaining a positive response to the user interface prompt; or the first virtual background image for the first user for the video collaboration session based on obtaining a negative response to the user interface prompt.

In one instance, the video collaboration session is an augmented reality collaboration session or virtual reality collaboration session and the first virtual background image is provided for a plurality of users for the video collaboration session including the first user. In one instance, the method may include providing at least one of a virtual avatar or a virtual avatar background for the first user based the first context keyword for the video collaboration session matching at least one keyword stored in association with the virtual avatar.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, and/or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
storing each of a plurality of virtual background images for a first user of a video collaboration system in association with one or more keywords, wherein the one or more keywords are configured for each of the plurality of virtual background images, at least in part, by the first user and wherein each of the plurality of virtual background images are encrypted based a content key that is unique to the first user; and
upon initiation of a video collaboration session for the first user via the video collaboration system, automatically unencrypting and providing a first virtual background image for the first user based, at least in part, on at least one of, a first context keyword for the video collaboration session matching at least one keyword stored in association with the first virtual background image or scheduling information associated with the video collaboration session, wherein the first virtual background image is unencrypted using the content key that is unique to the first user.

2. The method of claim 1, further comprising:
providing a user interface prompt to allow the first user to confirm whether the first virtual background image is to be utilized for the video collaboration session; and
setting one of:
the first virtual background image for the first user for the video collaboration session based on obtaining a positive response to the user interface prompt; or
a second virtual background for the first user for the video collaboration session based on obtaining a negative response to the user interface prompt.

3. The method of claim 1, wherein the first virtual background image is provided for one or more other users associated with the video collaboration session.

4. The method of claim 1, wherein the scheduling information includes at least one of:
a day indication;
a time indication; or
an indication identifying whether the video collaboration session is a personal session or a work-related session.

5. The method of claim 1, further comprising:
determining the first context keyword based on at least one of:
one or more words contained in an agenda of the video collaboration session;
one or more words contained in at least one past agenda of at least one previous video collaboration session; or
at least one role indication of the first user.

6. The method of claim 1, further comprising:
obtaining, during the video collaboration session, a transcript of the video collaboration session;
determining a second context keyword based on the transcript; and
automatically unencrypting and providing a second virtual background image for the first user based on the second context keyword matching at least one keyword stored in association with the second virtual background image, wherein the second virtual background image is unencrypted using the content key that is unique to the first user.

7. The method of claim 6, further comprising:
providing a user interface prompt to allow the first user to confirm whether the first virtual background image is to be utilized for the video collaboration session; and
setting one of:
the second virtual background image for the first user for the video collaboration session based on obtaining a positive response to the user interface prompt; or
the first virtual background image for the first user for the video collaboration session based on obtaining a negative response to the user interface prompt.

8. The method of claim 1, wherein the video collaboration session is an augmented reality collaboration session or virtual reality collaboration session and the first virtual background image is provided for a plurality of users for the video collaboration session including the first user.

9. The method of claim 1, further comprising:
providing at least one of a virtual avatar or a virtual avatar background for the first user based on the first context keyword for the video collaboration session matching at least one keyword stored in association with the virtual avatar.

10. One or more non-transitory computer readable storage media encoded with instructions that, when executed by a processor, cause the processor to perform operations, comprising:
storing each of a plurality of virtual background images for a first user of a video collaboration system in association with one or more keywords, wherein the one or more keywords are configured for each of the plurality of virtual background images, at least in part, by the first user and wherein each of the plurality of virtual background images are encrypted based a content key that is unique to the first user; and
upon initiation of a video collaboration session for the first user via the video collaboration system, automatically unencrypting and providing a first virtual background image for the first user based, at least in part, on at least one of, a first context keyword for the video collaboration session matching at least one keyword stored in association with the first virtual background image or scheduling information associated with the video collaboration session wherein the first virtual background image is unencrypted using the content key that is unique to the first user.

11. The media of claim 10, further comprising instructions that, when executed by the processor, cause the processor to perform further operations, comprising:
providing a user interface prompt to allow the first user to confirm whether the first virtual background image is to be utilized for the video collaboration session; and
setting one of:
the first virtual background image for the first user for the video collaboration session based on obtaining a positive response to the user interface prompt; or
a second virtual background for the first user for the video collaboration session based on obtaining a negative response to the user interface prompt.

12. (canceled)

13. The media of claim 10, further comprising instructions that, when executed by the processor, cause the processor to perform further operations, comprising:
determining the first context keyword based on at least one of:
one or more words contained in an agenda of the video collaboration session;
one or more words contained in at least one past agenda of at least one previous video collaboration session; or
at least one role indication of the first user.

14. The media of claim 10, further comprising instructions that, when executed by the processor, cause the processor to perform further operations, comprising:
obtaining a second context keyword based on a transcript of the video collaboration session; and
automatically unencrypting and providing a second virtual background image for the first user based on the second context keyword matching at least one keyword stored in association with the second virtual background image, wherein the second virtual background image is unencrypted using the content key that is unique to the first user.

15. The media of claim 14, further comprising instructions that, when executed by the processor, cause the processor to perform further operations, comprising:
providing a user interface prompt to allow the first user to confirm whether the first virtual background image is to be utilized for the video collaboration session; and
setting one of:
the second virtual background image for the first user for the video collaboration session based on obtaining a positive response to the user interface prompt; or
the first virtual background image for the first user for the video collaboration session based on obtaining a negative response to the user interface prompt.

16. An apparatus comprising:
at least one memory element for storing data; and
at least one processor for executing instructions associated with the data, wherein executing the instructions causes the apparatus to perform operations, comprising:
storing each of a plurality of virtual background images for a first user of a video collaboration system in association with one or more keywords, wherein the one or more keywords are configured for each of the plurality of virtual background images, at least in part, by the first user and wherein each of the plurality of virtual background images are encrypted based a content key that is unique to the first user; and
upon initiation of a video collaboration session for the first user via the video collaboration system, automatically unencrypting and providing a first virtual background image for the first user based, at least in part, on at least one of, a first context keyword for the video collaboration session matching at least one keyword stored in association with the first virtual background image or scheduling information associated with the video collaboration session wherein the first virtual background image is unencrypted using the content key that is unique to the first user.

17. The apparatus of claim 16, wherein executing the instructions causes the apparatus to perform further operations, comprising:
providing a user interface prompt to allow the first user to confirm whether the first virtual background image is to be utilized for the video collaboration session; and
setting one of:
the first virtual background image for the first user for the video collaboration session based on obtaining a positive response to the user interface prompt; or
a second virtual background for the first user for the video collaboration session based on obtaining a negative response to the user interface prompt.

18. The apparatus of claim 16, wherein the scheduling information includes at least one of:
a day indication;
a time indication; or
an indication identifying whether the video collaboration session is a personal session or a work-related session.

19. The apparatus of claim 16, wherein executing the instructions causes the apparatus to perform further operations, comprising:
determining the first context keyword based on at least one of:
one or more words contained in an agenda of the video collaboration session;
one or more words contained in at least one past agenda of at least one previous video collaboration session; or
at least one role indication of the first user.

20. (canceled)

21. (canceled)

22. The method of claim 1, wherein the one or more keywords associated with each of the plurality of virtual background images and the content key are encrypted based on a metadata key that is unique to the first user and the first virtual background image is unencrypted based, at least in part, on unencrypting the content key using the metadata key and then unencrypting the first virtual background image using the unencrypted content key.

23. The method of claim 22, wherein automatically unencrypting and providing the first virtual background image for the first user further comprises:
encrypting the first context keyword using the metadata key to generate an encrypted first context keyword;
querying a file index service using the encrypted context keyword to obtain an identifier for the first virtual background image; and
querying a collaboration server using the identifier to obtain the first virtual background image.
